(19) United States
(12) Patent Application Publication
(10) Pub. No.: US 2012/0158274 A1
(43) Pub. Date: Jun. 21, 2012

(54) Control device for an electrical high-current consumer, method for operating same, and computer program product

(76) Inventors: Jie Ge, Stuttgart-Hausen (DE); Achim Herzog, Backnang (DE); Falco Sengebusch, Stuttgart-Feuerbach (DE)

(21) Appl. No.: 13/379,770

(22) PCT Filed: Apr. 27, 2010
(86) PCT No.: PCT/EP2010/055658

§ 371 Date: Mar. 8, 2012

(30) Foreign Application Priority Data
Jun. 26, 2009 (DE) 10 2009 027 234.8

(51) Int. Cl. F02D 28/00

(52) U.S. Cl. 701/113

(57) ABSTRACT

A control device for an electrical high-current consumer is provided, e.g., a starter controller for a starter motor of an internal combustion engine in a motor vehicle, in a circuit having an internal ohmic resistor and further ohmic resistors, e.g., line resistors. The control device includes a microcomputer having a memory. To ensure a control device for standardized, defined control of the high-current consumer on different vehicle platforms, the control device includes an adapter having the microcomputer for adapting to the individual overall ohmic resistance of the circuit.

### BACKGROUND OF THE INVENTION

1. Field of the Invention

The present invention relates to a control device and a method for operating a control device for an electrical high-current consumer, e.g., a starter controller for a starter motor of an internal combustion engine in a motor vehicle, in a circuit having an internal ohmic resistor and having further ohmic resistors, in particular line resistors, in an overall circuit.

2. Description of the Related Art

It is known that a controller for controlling a high-current consumer changes a current and/or a voltage based on desired requirements.

For starting an internal combustion engine having a starter device using a start-stop system, it is known to use an electronic controller of the starter device.

Published German patent application document DE 10 2005 021 227 A1 describes a starter device for an internal combustion engine in a motor vehicle, having an electronic control device in which the starter motor is directly controlled by a transistor of the control device.

### BRIEF SUMMARY OF THE INVENTION

An object of the present invention is to refine a control device, a method for operating same, and a computer program product of the type described at the outset in order to ensure a control device for standardized, defined control of the high-current consumer on different vehicle platforms.

The control device according to the present invention includes an adapter for adapting to an individual overall ohmic resistance of a circuit. Thus, in particular for different overall ohmic resistances of the circuit or also for different circuits, the control device is able to adapt the energizing of a high-current consumer to the individual overall ohmic resistance of the circuit, in particular to act on the high-current consumer with a defined current. Different overall resistances result, for example, from different cable routings having different cable lengths, cable diameters, or cable materials on different motor vehicle platforms, or may also be caused by an aging or temperature influence, the internal line resistance in particular changing as a function of the temperature.

According to one preferred specific embodiment, the control device is a starter controller for a starter motor of an internal combustion engine in a motor vehicle, current for energizing the starter motor as a high-current consumer preferably being conducted through the starter controller, in particular using a battery as a current source. In particular also for motor vehicles, the energizing of the high-current consumer may advantageously be controlled with the aid of the control device according to the present invention, and a voltage dip in the vehicle electrical system may be reduced or avoided, in particular if high switch-on or starting currents impose a load on the vehicle electrical system, for example during a start-stop operation.

The adapter may be implemented using an electronic circuit system composed of analog components, for example a constant current source in analog circuit technology.

It is preferred that the control device, in particular the adapter, includes a circuit system having digital components, in particular a microcomputer having a memory, for example a program memory containing program instructions. Different functions for the adaptation may be cost-effectively implemented using digital circuit technology. With the aid of the microcomputer, the control device may be adapted to an individual overall resistance, in particular also of different electrical high-current consumers, with little effort.

The current is preferably measured and evaluated during the energizing of the high-current consumer. An influence of the individual overall ohmic resistance may be directly taken into account by measuring the current.

It is preferred that the adapter includes a current measuring device for measuring the current, in particular the current for energizing the high-current consumer, the current measuring device being in communication with the microcomputer for evaluating and accordingly controlling the high-current consumer. For the adaptation to an individual overall ohmic resistance of the circuit, an instantaneous state, in particular the overall resistance, of the circuit is ascertained by measuring the current, so that the high-current consumer is controlled in an appropriately defined manner. Thus, the controller is able to adapt to different vehicle platforms, or also to an overall resistance of the circuit which changes due to temperature or aging, for example.

The current measuring device preferably includes an analog-digital converter in order to ascertain the current by measuring a drop in voltage across a resistor, thus allowing cost-effective and accurate measurement as well as simple processing for the adaptation according to the present invention with the aid of the microcomputer.

One particularly preferred specific embodiment of the control device has at least two parallel-connected current paths for energizing the high-current consumer. The parallel-connected current paths are each provided with a power switch in order to, in each case, individually energize current paths to be energized individually by switching on the appropriate power switch. An overall current which is delivered via the control device for the energizing, i.e., which flows through the control device for the energizing, may then be controlled in that specified current paths, which preferably are defined by an energizing group, as explained below, are energized by the parallel-connected current paths with the aid of their particular power switches, so that the delivered current is the sum of the individual currents of each energized current path.

The energizing group is merely information concerning which, or how many, of the parallel-connected current paths are to be energized. In particular, the energizing group may also represent current paths which at a particular given moment are not energized, but instead are to be energized only at a later point in time. The energizing group may also include all of the parallel-connected current paths, in particular for a maximum overall current, or may also include none of the current paths to be energized, for example in order to interrupt the energizing of the high-current consumer, for example for pulsed operation.

The energizing group is preferably established by the adapter, in particular independently by the microcomputer of the control device, for example as a list or as a quantity. The energizing group may also be changed or adapted with the aid of the microcomputer and stored in the memory, for example in order to energize the current paths, which are represented by the energizing group, at a later point in time. An easily implementable controller for energizing a high-current consumer is thus made possible, namely, only by switching the power switches corresponding to the energizing group, and in particular, by controlling by the microcomputer.

Ultimately, the resistance of the overall circuit, which optionally also includes the parallel-connected current paths, determines the current for energizing the high-current consumer. Since each of the parallel current paths has a power switch, the overall internal resistance of the control device, i.e., also the resulting overall resistance of the circuit, may be adapted, and the high-current consumer may thus be controlled in a defined manner.

Each of the parallel-connected current paths preferably has a current limiting device, in particular an ohmic resistor. The current for energizing each of the current paths may thus be set, but at least the ratio of the currents of at least two energized parallel current paths may be established.

Commercial resistors, in particular having a metallic conductor, are selected as a current limiting device. These resistors are available in robust designs which are particularly suited for motor vehicles, or they are also available in inexpensive designs. Line resistors of the parallel-connected current paths, which are defined in particular by the material, the length, and the cross-sectional area of the lines, and which are inexpensively and easily implementable, for example as conventional cables, may also be used as a current limiting device.

The power switches may also be designed as electromagnetic switches, for example as a motor vehicle relay. However, electronic components, for example transistors, and particularly preferably field effect transistors, are preferably selected as power switches. These types of components may be easily integrated into and installed in the control device, and have a long service life, a low weight, and a small size.

In other respects, an individual power switch may also include a plurality of parallel-connected switches, i.e., parallel-connected field effect transistors, for example, so that the current for energizing a current path is also distributed over a plurality of individual switches, each of which may switch lower currents, i.e., which may be more cost-effective and have a longer service life or also a fairly small size. In addition, such an individual current path may be acted on by a current which is greater than a maximum current that is switchable using one field effect transistor that is available in each case.

The object of the present invention is also achieved by a computer program product, in that the computer program product is loadable in a program memory containing program instructions in order to carry out all the steps of one of the methods mentioned above or below, when the computer program product is executed in the control device according to the present invention, in particular the microcomputer.

As mentioned above, the current for energizing the high-current consumer via the current paths may be controlled by the control device, it preferably being possible for different currents to be set via a different selection or quantity of current paths to be energized, i.e., different energizing groups. Different current paths may be designed for different currents, for example using different ohmic resistors as current limiting devices, i.e., for making different contributions to an overall current. Alternatively, different current paths may be designed for each of the identical currents, for example by using the same ohmic resistors as current limiting devices. In the latter case, the overall current, i.e., the current for energizing the high-current consumer, may be easily controlled merely due to the number of the particular energized current paths.

In addition, path information concerning properties of the current paths, in particular of the current limiting devices, in particular preferably concerning the values of the ohmic resistors, may be stored by the adapter in the memory of the microcomputer, so that the current for energizing the high-current consumer which results from an energizing group is computable by the microcomputer, and is controllable in a defined manner by switching appropriate power switches.

It is preferred that the current for energizing the high-current consumer is controlled by changing the energizing group, in order to ultimately energize a different combination or a different selection of the parallel-connected current paths.

If a current for energizing the high-current consumer exceeds a threshold value, the energizing group may be changed in such a way that the overall resistance of the current paths which are represented by the energizing group is increased; i.e., the current is decreased. Accordingly, if a current for energizing the high-current consumer is below a threshold value, which preferably is different from the first threshold value, the energizing group may be changed in such a way that the overall resistance of the current paths which are represented by the energizing group is reduced; i.e., the current is increased. This may be achieved in that the number of current paths constituting the energizing group remains unchanged, in particular due to different current limiting devices for different current paths.

However, if a current for energizing the high-current consumer exceeds a threshold value, the energizing group is preferably reduced; i.e., the number of parallel-connected current paths which are represented by the energizing group is reduced, and if the current is below a threshold value, which preferably is different from the first threshold value, the energizing group is increased; i.e., the number of parallel-connected current paths which are represented by the energizing group is increased. Thus, the current is controlled simply by changing the number of current paths to be energized. The current limiting devices, in particular the resistors, of at least two, preferably all, parallel-connected current paths may essentially be the same, i.e., in particular may have essentially the same ohmic resistance.

The current paths which are determined by the energizing group are preferably only energized simultaneously; i.e., their power switches are switched at the same time. An overload of an individual current path may thus be avoided. In addition, the current, in particular a switch-on or starting current, of the high-current consumer is defined at any time as a result of the selection.

According to one preferred specific embodiment, the current for energizing the high-current consumer, or also a test current, is measured prior to a working phase of the high-current consumer, in particular with the aid of the measuring device, for example during start-up of an electric machine, in particular the starter motor, which preferably is not under load, and in particular preferably without being coupled to the internal combustion engine. It is preferred to briefly energize the high-current consumer, and in particular also to crank same, prior to the working phase for a maximum of 200 ms, 100 ms, 50 ms, 25 ms, or 15 ms (increasingly preferred in this order). A current consumption under low load of the high-current consumer may thus be measured while also taking the instantaneous, in particular age- and temperature-related, overall resistance of the circuit into account in the evaluation. The control device, with the aid of the adapter, may then be adapted to this individual overall resistance in order to control the high-current consumer in a defined manner, the energizing group preferably being adapted, i.e., changed, by the adapter, in particular with the aid of the microcomputer.

According to one method which refines the present invention, when the energizing group is changed, the changed energizing group may be stored by the adapter, and the high-current consumer may be energized via the current paths defined by the changed energizing group, in particular also at a later point in time, preferably during the working phase.

Thus, as a whole, the current for energizing the high-current consumer via current paths according to a first energizing group may be measured, a changed energizing group may be specified for adapting the control device, the changed energizing group may be stored, and the high-current consumer may be energized via the parallel-connected current paths which are defined by the changed energizing group. The adapter preferably carries out these steps independently, and thus controls the current in a self-learning manner.

It is preferred to interrupt the energizing of the high-current consumer after the previously mentioned brief cranking in order to measure the current, and to energize the high-current consumer, preferably after the adaptation according to the present invention, in a defined manner only after a brief pause of a maximum of 500 ms, 300 ms, or 100 ms, for example. A voltage dip, in particular in a battery-supplied circuit in a motor vehicle, may be reduced in this way.

In one particularly preferred method, the starter motor of an internal combustion engine in a motor vehicle is operated with the aid of the control device, the control device having parallel-connected current paths, each having one power switch and one current limiting device, in particular in that the starter motor is energized over all current paths prior to the working phase, and the starting current is measured during, in particular brief, cranking of the starter motor, and if the starting current exceeds a threshold value, an energizing group of current paths to be energized is reduced by at least one, preferably exactly one, current path, and if the starting current is below a, in particular different, threshold value, the energizing group is increased by at least one, preferably exactly one, current path to be energized, the energizing group is stored, and in the working phase the starter motor is energized via the current paths which are represented by the stored energizing group. Thus, the circuit may be routinely checked, in particular also prior to each working phase of the starter motor, and for the working phase the overall resistance of the circuit may be decreased or increased, for example in order to delimit the maximum starting current or to increase the drive power.

It is particularly preferred that the control device has two, preferably three, parallel-connected current paths, each having a power switch, in particular a field effect transistor, and in each case having a current limiting device, in particular an ohmic resistor, and that the previously mentioned reduced energizing group includes only one of the two, or only two of the three, current paths. With little complexity of circuitry, two or three parallel-connected current paths allow a total of three or seven, respectively, different combinations for energizing the current paths, and consequently, allow different overall currents for a defined energizing of the high-current consumer.

In addition, the control device may be a component of a starter-based start-stop system for internal combustion engines in a motor vehicle. In particular, but also independently thereof, a starting operation, in particular a cold start, of the internal combustion engine may be achieved by maximum energizing of the starter motor by energizing all parallel-connected current paths. As previously described, the starting current may be measured, a changed energizing group specified, and the changed energizing group stored by the adapter, so that during a starting operation, in particular during a subsequent warm start, the starter motor may be energized by an adapted current by energizing the current paths which are specified by the stored, changed energizing group. The power of the starter motor may thus be adapted to the particular situation, for example a warm or cold start.

In addition, as previously mentioned, such a control device may also be advantageously used on different motor vehicle platforms, and the energizing of the starter motor may be independently adapted to different current routings with the aid of the adapter, so that modification of the control device corresponding to the particular motor vehicle platform is dispensed with, and the control device adapts in a self-learning manner.

Furthermore, if the measured current for energizing the high-current consumer exceeds a maximum current, the energizing of all current paths may be terminated by switching off all the power switches. The risk of an overload, in particular of the high-current consumer, may be reduced in this way.

### BRIEF DESCRIPTION OF THE DRAWINGS

FIG. 1 shows a schematic illustration of a circuit together with a starter device of a motor vehicle.

FIG. 2 shows a schematic illustration of a method according to the present invention for operating the control device.

### DETAILED DESCRIPTION OF THE INVENTION

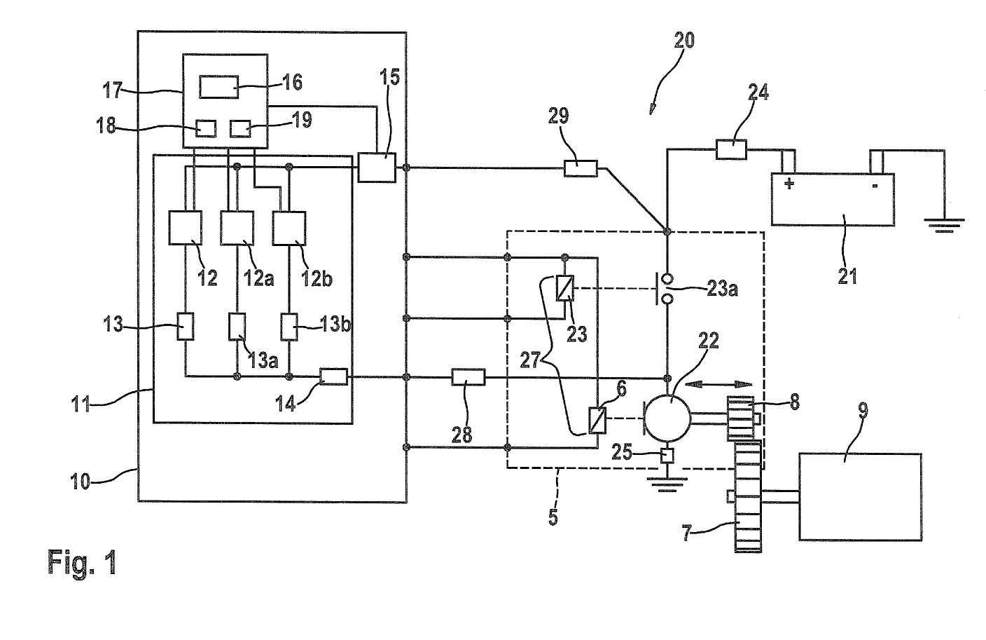

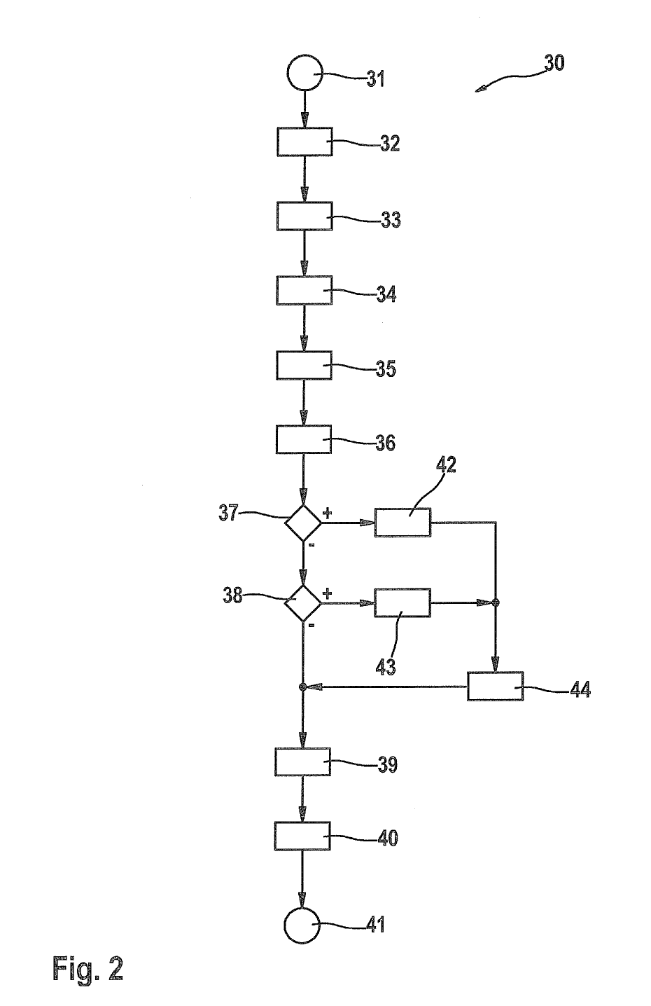

FIG. 1 shows a schematic illustration of a circuit 20 together with a starter device of a motor vehicle, including a control device 10 according to the present invention whose method of operation is represented in FIG. 2, and a starter 5. The starter device is a starter-based start-stop system for starting an internal combustion engine 9 with the aid of a starter motor 22, in particular in that a starter pinion 8 meshes with an annular gear 7 of internal combustion engine 9.

Circuit 20 has the following connected in series: a battery 21 having an internal resistor 24 of approximately 4 mΩ to 6 mΩ, for example, control device 10 having a line resistor 14, three parallel-connected current paths 11, each having a resistor 13, 13a, 13b as a current limiting device and each having a field effect transistor 12, 12a, 12b as a power switch, starter motor 22 having an internal resistor 25, and two line resistors 28, 29 of circuit 20, which, for example, are approximately 1 mΩ to 2 mΩ and 2.5 mΩ, respectively. A safety switch 15 is connected in series to parallel-connected current paths 11 in order to prevent undesired energizing of starter motor 22.

Circuit 20 also includes a starter relay 27, which includes a switching relay 23 having a switching contact 23a for energizing starter motor 22, and a meshing relay 6 for meshing of starter pinion 8. This is a redundantly connected starter relay 27, starter motor 22 thus being energizable via switching contact 23a of switching relay 23 or also via control device 10.

In circuit 20, in particular internal resistors 24, 25 and line resistors 28, 29 are subject to temperature and aging influences. As explained below, the energizing of starter motor 22 via parallel-connected current paths 11 is controlled in such a way that the temperature and/or aging influences, in particular on resistors 14, 24, 25, 28, 29, are compensated for.

Parallel-connected current paths 11 may in each case be energized individually or also in any desired combination by an adapter 17 with the aid of field effect transistors 12, 12a, 12b, so that control device 10 controls in a defined manner the current delivered to starter motor 22 via the resulting overall resistance of switched-on parallel current paths 11. The maximum current achieved during the energizing of all parallel-connected current paths 11 is 750 A.

In the present exemplary embodiment, at 120° C. resistors 13, 13a, 13b are approximately 17.7 mΩ, 10.9 mΩ, and 8.7 mΩ, respectively, so that in addition to a state in which all parallel-connected current paths 11 are switched off, i.e., are practically nonconductive or high-resistance, seven additional, different values of the overall resistance may also be set, for controlling the current via combinations of parallel-connected resistors 13, 13a, 13b. Internal line resistor 14 is approximately 1.5 mΩ.

Adapter 17 for controlling the power switches has a microcomputer 18 together with a memory 19 as well as a computer program product, which are designed for a method according to the present invention, described in greater detail in FIG. 2. Control device 10 also has a current measuring device 16 for measuring the current delivered from battery 21 to starter motor 22 with the aid of control device 10, the current exactly corresponding to the sum of the currents of each of energized parallel-connected current paths 11. The current is ascertained, with the aid of current measuring device 16, based on the drop in voltage across parallel-connected current paths 11, so that resistors 13, 13a, 13b are used as a shunt. In an alternative exemplary embodiment, the current may also be measured with the aid of resistor 14, or also an additional resistor connected in series.

FIG. 2 schematically describes a method 30 for operating control device 10. As previously mentioned, the present exemplary embodiment describes a starter-based start-stop system. Thus, FIG. 2 shows an operating method for control device 10 which is repeated for each starting operation. A distinction may be made between a so-called cold start, i.e., a start of internal combustion engine 9 after a fairly long resting period, which in particular results in a temperature drop greatly below the operating temperature of internal combustion engine 9, and a warm start, which occurs after only a brief interruption in the operation of internal combustion engine 9.

Beginning 31 of a starting operation of internal combustion engine 9 is initiated, for example, by activating an ignition switch for a cold start, or by depressing a gas pedal or also by releasing a brake pedal for a warm start.

A stored energizing group of current paths 11 to be energized is retrieved from memory 19 of adapter 17 in a step 32. The energizing group is thus information concerning which of parallel current paths 11 is/are to be energized. For a cold start, an energizing group which includes all three current paths 11 is preferably retrieved from memory 19 in step 32 in order to select the overall resistance of parallel current paths 11 to be as low as possible, and therefore to select the energizing, i.e., the power of starter motor 22, to be as high as possible.

Subsequently, in a step 33, the power switches, namely, field effect transistors 12, 12a, 12b of the current paths which are represented by the energizing group, are switched on for energizing starter motor 22. As a result of the energizing, in a step 34, starter motor 22 is cranked for approximately 15 ms, and in a step 35, a starting current, i.e., the current during cranking of starter motor 22, is measured, and all power switches are switched off in a step 36.

In a step 37, it is checked whether the measured starting current exceeds an upper threshold value. If this is the case, in a step 42, a new energizing group is specified for an increased overall resistance of current paths 11 to be energized by reducing the energizing group by one current path. Microcomputer 18 of adapter 17 stores the new energizing group in memory 19 in a step 44.

Otherwise, in a step 38, it is checked whether the starting current is below a lower threshold value. If this is the case, in a step 43, a new energizing group is specified for a decreased overall resistance of current paths 11 to be energized by increasing the energizing group by one current path. Adapter 17 stores the new energizing group in memory 19 in step 44.

In a working phase 39, starter motor 22 is subsequently energized via parallel-connected current paths 11, in particular, only via current paths 11 which are represented by the energizing group, which has optionally been changed in steps 42 or 43, in order to start internal combustion engine 9.

As soon as internal combustion engine 9 starts, power switches 12, 12a, 12b are switched off in a step 40 in order to discontinue the energizing of starter motor 22 and terminate the starting operation in a step 41.

Control device 10 may adapt in a self-learning manner to permanent and/or long-term changes in circuit 20 by adapting the energizing group if the current is above or below certain threshold values, and storing the energizing group permanently and/or for a long period of time. Thus, for example, aging or temperature effects may be compensated for, or controller 10 may also be used in different circuits 20, for example on different motor vehicle platforms, the controller setting itself in a self-learning manner for particular circuit 20 during initial operation by ascertaining a suitable energizing group for subsequent energizing of starter motor 22 and storing same.

In another exemplary embodiment, which is not illustrated, control device 10 has only two parallel-connected current paths 11. The starting current of starter motor 22 may thus be controlled in three stages. Such a control device is manufacturable in a more resource-conserving and cost-effective manner.

Another exemplary embodiment, which is not illustrated, differs from those previously mentioned in that control device 10 also detects a temperature of internal combustion engine 9, and if the temperature is below a certain threshold value the control device changes the energizing group in such a way that the overall resistance of current paths 11 to be energized is reduced, or also the energizing group is defined in such a way that all parallel-connected current paths 11 are energized in order to set a maximum current.

Other exemplary embodiments, which are not illustrated, differ from the exemplary embodiments previously described with regard to the high-current consumer, so that, instead of starter motor 22, a resistance heating element, for example of a seat heater, a rear window or windshield defroster, or an electric motor drive, for example for a vehicle door or a vehicle side window, is energized by control device 10 according to the present invention.

Other exemplary embodiments, which are not illustrated, differ from those previously described in that the current limiting devices, i.e., resistors 13, 13a, 13b of parallel-connected current paths 11, all have essentially the same value. The current is then controlled directly as a result of the number of energized current paths 11, so that the energizing group represents information preferably in the form of an integer, which is incremented to increase the current for energizing starter motor 22, and is decremented to reduce the current. All the figures show only schematic illustrations which are not to scale. In other respects, reference is made in particular to the graphical illustrations as being essential to the present invention.

1-11. (canceled)

12. A control device for an electrical high-current consumer situated in a circuit having ohmic line resistors, comprising:
an internal ohmic resistor in the circuit for energizing the high-current consumer;
an adapter for adapting to the individual overall ohmic resistance of the circuit, wherein the adapter includes a microcomputer and a memory; and
at least two parallel-connected current paths configured to be selectively energized for energizing the high-current consumer, wherein each current path includes one power switch and one current limiting device, and wherein the adaptor provides information regarding which of the parallel-connected current paths to be energized.

13. The control device as recited in claim 12, wherein the control device is a starter controller for a starter motor of an internal combustion engine, and wherein the adapter includes a current measuring device for measuring a current for energizing the high-current consumer, the current measuring device being in communication with the microcomputer to enable evaluation and control of the high-current consumer.

14. A method for operating a control device for energizing an electrical high-current consumer situated in a circuit having ohmic line resistors, the control device being provided with an internal ohmic line resistor in the circuit, and the control device having an adapter provided with a microcomputer and a memory, the method comprising:
applying, by the control device, a current to the high-current consumer to energize the high-current consumer; and
adapting, by the control device, the energizing of the high-current consumer to the individual overall ohmic resistance of the circuit, wherein the adapting includes:
providing at least two parallel-connected current paths configured to be selectively energized for energizing the high-current consumer, wherein each current path includes one power switch and one current limiting device, and wherein the adaptor provides information regarding which of the parallel-connected current paths to be energized.

15. The method as recited in claim 14, wherein the control device is a starter controller and the high-current consumer is a starter motor of an internal combustion engine, and wherein the current is measured and evaluated during the energizing of the starter motor.

16. The method as recited in claim 15, wherein:
if the current for energizing the starter motor exceeds a first predefined threshold value, reducing the number of the current paths to be energized; and
if the current for energizing the starter motor is below a second predefined threshold value, increasing the number of the current paths to be energized.

17. The method as recited in claim 14, wherein a starting current for energizing the high-current consumer is measured prior to a working phase of the high-current consumer.

18. The method as recited in claim 16, wherein when there is a change in the number of the current paths to be energized, the adaptor stores information identifying energizing elements defining the changed number of the current paths to be energized, and the starter motor is energized via the changed number of the current paths.

19. The method as recited in claim 16, wherein:
at least three parallel-connected current paths are provided;
prior to a working phase of the starter motor, the at least three parallel-connected current paths are energized in a cranking phase;
a starting current is measured during the cranking phase;
if the starting current exceeds the first predefined threshold value, the number of the current paths to be energized is reduced by at least one current path;
and if the starting current is below the second predefined threshold value, the number of the current paths to be energized is increased by at least one current path; and
information identifying energizing elements defining the changed number of the current paths to be energized is stored, and the starter motor is energized via the changed number of the current paths during the working phase the starter motor.

20. The method as recited in claim 16, wherein if the current for energizing the high-current consumer exceeds the first predefined threshold value, the energizing of all current paths is terminated by switching off all the power switches of the current paths.

21. A non-transitory computer-readable data storage medium storing a computer program having program codes which, when executed in a computer, performs a method for operating a control device for energizing an electrical high-current consumer situated in a circuit having ohmic line resistors, the control device being provided with an internal ohmic line resistor in the circuit, and the control device having an adapter provided with a microcomputer and a memory, the method comprising:
applying, by the control device, a current to the high-current consumer to energize the high-current consumer; and
adapting, by the control device, the energizing of the high-current consumer to the individual overall ohmic resistance of the circuit, wherein the adapting includes:
providing at least two parallel-connected current paths configured to be selectively energized for energizing the high-current consumer, wherein each current path includes one power switch and one current limiting device, and wherein the adaptor provides information regarding which of the parallel-connected current paths to be energized.
